(19) United States
(12) Patent Application Publication
(10) Pub. No.: US 2025/0278750 A1
(43) Pub. Date: Sep. 4, 2025

(54) MACHINE LEARNING MODEL FRAMEWORK TO IDENTIFY POTENTIAL CUSTOMERS AND DISPLAY THEREOF

(71) Applicant: Charles Schwab & Co., Inc, San Francisco, CA (US)

(72) Inventors: Swaroop KROTHAPALLI, Georgetown, TX (US); Shibashis MUKHERJEE, Cedar Park, TX (US); Jeffery Dean CARLSON, Phoenix, AZ (US)

(73) Assignee: Charles Schwab & Co., Inc, San Francisco, CA (US)

(21) Appl. No.: 18/591,592

(22) Filed: Feb. 29, 2024

(51) Int. Cl. G06Q 30/0202

(52) U.S. Cl. CPC G06Q 30/0202

(57) ABSTRACT

A system for identifying a targeted set of prospect clients from a pool of existing clients is caused to receive a dataset having securities data, household data, and forecasted data, determine, with a machine learning model, a model score for each household of the households based on the received dataset, filter the households based on the model score for each household and a threshold score to generate remaining households, determine a prioritization score for each remaining household of the remaining households, prioritize the remaining households based on the prioritization score for each remaining household of the remaining households, and generate and display a user interface including a list of the prioritized remaining households having prospect clients from the pool of existing clients. Other example systems, methods, and non-transitory computer readable medium for identifying a targeted set of prospect clients from a pool of existing clients are also disclosed.

### BACKGROUND

### Field

Various example embodiments relate to methods, apparatuses, systems, and/or non-transitory computer readable mediums providing a machine learning model framework for identifying potential customers and display thereof, and more particularly, to methods, apparatuses, systems, and/or non-transitory computer readable media for identifying potential customers through machine leaning models and generating user interfaces, such as graphical user interfaces, for displaying prioritized customers from the identified potential customers.

### Description of the Related Art

Machine learning generally relates to the development of algorithms that can identify patterns in datasets and/or make decisions based on datasets. For instance, machine learning algorithms or models may be supervised models that are trained on known and labeled datasets. Once trained, the machine learning models are executed by computer processors to uncover patterns in other datasets. In other scenarios, the machine learning models may be unsupervised models that uncover patterns in unlabeled datasets. In such examples, the supervised and unsupervised machine learning models rely on a set of rules to uncover the patterns in the data.

### SUMMARY

At least one example embodiment is directed towards a system for identifying a targeted set of prospect clients from a pool of existing clients.

In at least one example embodiment, the system may include a memory storing computer readable instructions, and processing circuitry configured to execute the computer readable instructions to cause the system to, receive a dataset having securities data, household data, and forecasted data. The securities data includes hard-to-borrow (HTB) securities and a demand rate for each HTB security of the HTB securities, the household data includes attributes specific to households, the forecasted data includes predicted financial attributes specific to the households, and each household includes at least one client associated with at least one existing account owning at least one HTB security of the HTB securities. The system is further caused to determine, with a machine learning model, a model score for each household of the households based on the received dataset, filter the households based on the model score for each household and a threshold score to generate remaining households, determine a prioritization score for each remaining household of the remaining households based on a price, a household quantity, and the demand rate of the at least one HTB security, prioritize the remaining households based on the prioritization score for each remaining household of the remaining households, and generate and display a user interface including a list of the prioritized remaining households having prospect clients from the pool of existing clients.

Some example embodiments provide that the system is further caused to initiate communication with a client associated with an existing client account in the household having the highest prioritization score.

Some example embodiments provide that the system is further caused to automatically initiate communication with the client in response to the generated user interface.

Some example embodiments provide that the existing client account in the household having the highest prioritization score is a first existing client account, and the household having the highest prioritization score includes a second existing client account of the pool of existing accounts and the client.

Some example embodiments provide that the system is further caused to generate a report with a client response of the initiated communication.

Some example embodiments provide that the machine learning model is a first machine learning model and the financial attributes specific to the households are predicted by a second machine learning model based on the attributes associated with the households and the client response.

Some example embodiments provide that the system is further cause to filter the households based on at least one of existing client input, a total number of assets, and the client response.

Some example embodiments provide that the machine learning model includes a decision tree machine learning algorithm.

Some example embodiments provide that the machine learning model is a first machine learning model and the financial attributes specific to the households are predicted by a second machine learning model based on the attributes associated with the households.

Some example embodiments provide that the system is further caused to train the machine learning model based on the received dataset.

At least one example embodiment is directed towards a method for identifying a targeted set of prospect clients from a pool of existing clients.

In at least one example embodiment, the method may include receiving, at a machine learning model, a dataset having securities data, household data, and forecasted data. The securities data includes HTB securities and a demand rate for each HTB security of the HTB securities, the household data includes attributes specific to households, the forecasted data includes predicted financial attributes specific to the households, and each household includes at least one client associated with at least one existing account owning at least one HTB security of the HTB securities. The method may further include determining, with the machine learning model, a model score for each household of the households based on the received dataset, filtering the households based on the model score for each household and a threshold score to generate remaining households, determining a prioritization score for each remaining household of the remaining households based on a price, a household quantity, and the demand rate of the at least one HTB security, prioritizing the remaining households based on the prioritization score for each remaining household of the remaining households, and generating and displaying a user interface including a list of the prioritized remaining households having prospect clients from the pool of existing clients.

Some example embodiments provide that the method further includes storing automatically initiating electronic communication with a client associated with an existing client account in the household having the highest prioritization score.

Some example embodiments provide that the existing client account in the household having the highest prioritization score is a first existing client account, and the household having the highest prioritization score includes a second existing client account of the pool of existing accounts and the client.

Some example embodiments provide that the method further includes generating a report with a client response of the initiated communication.

Some example embodiments provide that the machine learning model is a first machine learning model and the financial attributes specific to the households are predicted by a second machine learning model based on the attributes associated with the households and the client response.

Some example embodiments provide that filtering the households includes filtering the households based on at least one of existing client input, a total number of assets, and the client response.

Some example embodiments provide that the machine learning model includes a decision tree machine learning algorithm.

Some example embodiments provide that the method further includes training the machine learning model based on the received dataset.

At least one example embodiment is directed to a non-transitory computer readable medium.

In at least one example embodiment, the non-transitory computer readable medium stores computer readable instructions, which when executed by processing circuitry, causes a system including the processing circuitry to, receive a dataset having securities data, household data, and forecasted data. The securities data includes HTB securities and a demand rate for each HTB security of the HTB securities, the household data includes attributes specific to households, the forecasted data includes predicted financial attributes specific to the households, and each household includes at least one client associated with at least one existing account owning at least one HTB security of the HTB securities. The system is further caused to determine, with a machine learning model, a model score for each household of the households based on the received dataset, filter the households based on the model score for each household and a threshold score to generate remaining households, determine a prioritization score for each remaining household of the remaining households based on a price, a household quantity, and the demand rate of the at least one HTB security, prioritize the remaining households based on the prioritization score for each remaining household of the remaining households, and generate and display a user interface including a list of the prioritized remaining households.

Some example embodiments provide that the system is further caused to automatically initiate communication with a client associated with an existing client account in the household having the highest prioritization score.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a block diagram of a system relying on a machine learning model to identify potential customers, according to at least one example embodiment;

FIG. 2 illustrates a block diagram of another system relying on a machine learning model to identify potential customers, according to at least one example embodiment;

FIGS. 3-4 illustrates example user interfaces including lists of prioritized households output by the system of FIG. 1, according to at least one example embodiment;

FIG. 5 illustrates an example user interface including a report showing a client response of an initiated communication provided by the system of FIG. 1, according to at least one example embodiment;

FIG. 6 illustrates a block diagram of an example computing device of the systems of FIGS. 1-2, according to at least one example embodiment; and

FIG. 7 illustrates an example method for identifying, with a machine learning model, potential customers, according to at least one example embodiment.

In the drawings, reference numbers may be reused to identify similar and/or identical elements.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A company may include customers or clients having investment accounts through the company. The existing clients often own one or more securities (e.g., stocks in publicly traded companies) in their investment accounts. Sometimes, individual investors or financial institutions (e.g., hedge funds, etc.) have a need for such securities for various option trading activities, such as short selling. For instance, the investors or financial institutions may place a short order for a number of shares of a stock. The stock may be classified as easy-to-borrow (ETB) or hard-to-borrow (HTB). For example, if the stock is immediately available to short, that stock may be an ETB security. In such cases, a broker may lend available shares of the stock to the investors or financial institutions for the short order. In other examples, the stock may be a HTB security if a limited number of shares are available. In such examples, a time sensitive request may be made to the company for the stock shares. When this occurs, the company may attempt to locate shares of the HTB security owned by its existing clients and then lend the shares to the investors or financial institutions for the short order. To do so, however, individuals at the company are tasked with identifying such existing clients and then communicating with the identified clients to gain approval of such actions. Oftentimes, the identification of clients is time-consuming, unreliable, and inefficient, as many existing clients that are contacted may be uninterested in such actions. As such, the identification of potentially interested clients and subsequent lending approval from the interested client may create inefficiencies and unsatisfactory delays, resulting in the company being unable to fulfill the time sensitive request for the stock shares.

At least one example embodiment herein refers to methods, systems, devices, and/or non-transitory computer readable media for providing a machine learning based framework that leverages one or more machine learning (ML) models to identify a targeted set of prospect accounts from a pool of existing accounts (e.g., over thirty million accounts, etc.) for participating in a securities lending program that, for example, makes hard-to-borrow (HTB) securities available to investors or financial institutions (e.g., hedge funds, etc.) requesting such securities for various option trading activities, such as short selling. More specifically, the framework generates model scores for households having one or more accounts with the ML models, filters out any undesirable households, prioritizes the remaining households based on specific criteria, and generates user interfaces (e.g., a graphical user interface (GUI)) with the prioritized households having prospect accounts for participating in the securities lending program. Then, the framework or analysts for the securities lending program may initiate communication with clients associated with the prospect accounts of the prioritized households. As such, the framework efficiently and accurately identifies and prioritizes the households having clients with accounts that would most likely be amenable to participating in the securities lending program as compared to manual, non-ML based systems, thereby allowing clients to be contacted in a timely manner as client rates associated with the HTB securities are time sensitive. In such examples, the framework also provides, to the analysts, key information about the households and the clients that they would be unable to glean on their own.

Through machine learning, the one or more models may be trained and tuned according to various attributes that result in clients participating in the securities lending program. For example, and further explained herein, the models may be trained on hundreds of different attributes specific to households that actually participate in the securities lending program. In doing so, the performance of the ML models may be improved continuously through collected and/or model generated data from the framework and/or feedback from the analysts initiating communication with clients.

For example, according to at least one example embodiment, the machine learning based framework for identifying a targeted set of prospect accounts from a pool of existing accounts to participate in a securities lending program may receive a dataset including various kinds of data relating to HTB securities, attributes specific to households, and predicted financial attributes specific to the households. Then, according to at least one example embodiment, the framework leverages at least one ML model to determine a model score based on the received dataset for each household. Once the model scores are determined, the framework filters out (e.g., excludes) any households based on one or more exclusion rules to generate remaining households and determines a prioritization score for each remaining household. The framework then prioritizes the remaining households based on the prioritization score for each remaining household, and generates a user interfaces including a list of the prioritized remaining households (e.g., out of a vast collection of possible households, such as over one million different households, etc.).

According to at least one example embodiment, the machine learning based framework or analysts for the securities lending program may, in response to the generated user interface (e.g., functioning as a generated alert), initiate communication (e.g., automatically initiate communication) with clients associated with existing client accounts in the prioritized households for participating in the securities lending program. Then, the framework may generate client responses based on the initiated communication for training (or retraining) of the ML model. As such, existing clients that are most likely amenable to participating in the securities lending program are quickly and accurately identified through the ML model, the performance of which is improved through feedback from feedback.

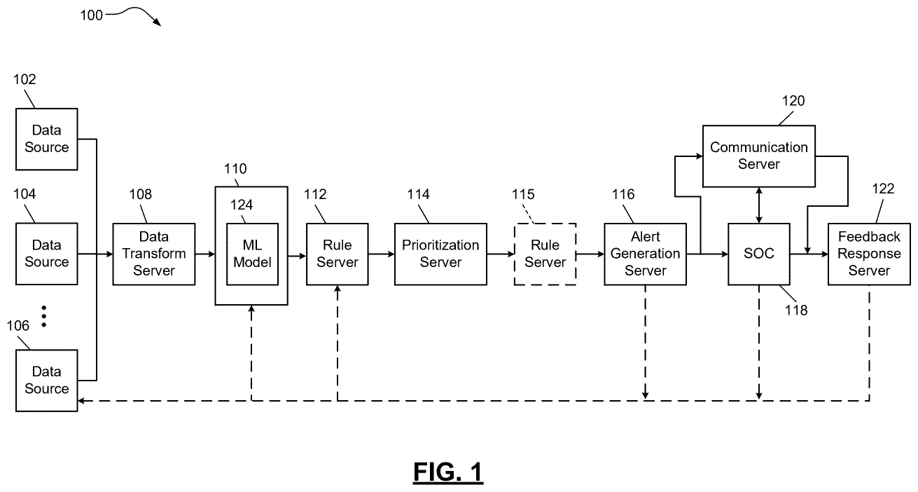

FIG. 1 illustrates a system 100 associated with a machine learning based framework according to at least one example embodiment. The machine learning based framework may assist in identifying a targeted set of prospect accounts from a pool of existing accounts to participate in a securities lending program for various option trading activities, such as short selling. The machine learning based framework of FIG. 1 may be implemented on site, in a cloud (e.g., a public cloud, etc.), or a hybrid of the two.

As shown in FIG. 1, the system 100 generally includes a data transform server 108, a ML server 110, a rule server 112, a prioritization server 114, an alert generation server 116, a sales operation center (SOC) 118, a communications server 120, and a feedback response server 122. In the example of FIG. 1, the ML server 110 can execute one or more ML models 124. While the example system 100 of FIG. 1 is shown as including one ML model 124, it should be appreciated that the system 100 may include more ML models if desired. Additionally, according to some example embodiments, the data transform server 108, the ML server 110, the rule server 112, the prioritization server 114, the alert generation server 116, the communications server 120, and/or the feedback response server 122 may be implemented as a single server, or one or more of the data transform server 108, the ML server 110, the rule server 112, the prioritization server 114, the alert generation server 116, the communications server 120, and/or the feedback response server 122 may be implemented as a plurality of servers, etc.

According to some example embodiments, the data transform server 108 receives one or more datasets from various data sources 102, 104, 106. While the example system 100 of FIG. 1 is shown as including three data sources 102, 104, 106, it should be appreciated that the system 100 may include more or less data source for providing the datasets. The datasets may be provided in a batch mode (e.g., a set of collected data over time is sent periodically) or a streaming mode (e.g., collected data is transmitted and fed continuously in real-time). In various embodiments, the data transform server 108 may perform data preprocessing to prepare the received data (e.g., raw data) to enable feature engineering. For instance, some or all of the raw data from the data sources 102, 104, 106 may be in unusable and/or undesirable formats. In such examples, the data transform server 108 may normalize (e.g., translate or transform) the raw data having unusable and/or undesirable formats into a standardized format, and then aggregate the normalized data (and any raw data already in a useable and/or desirable format).

In various embodiments, any one or more of the data source 102, 104, 106 may provide the one or more datasets having securities data, household data, and/or forecasted data. For example, the securities data may include HTB securities (e.g., 60-80 stocks, etc.) and a demand rate for each HTB security. In such examples, the demand rate may represent the demand for a specific HTB security over a defined period of time (e.g., an hour, a day, a week, etc.). As one example, the demand rate for one HTB security may be 200 requests per day.

Additionally, the household data may include various attributes specific to households. For example, each household has at least one client associated with an existing account owning at least one HTB security. As such, one household may include one client associated with one account owning one or more HTB securities, or multiple clients associated with multiple accounts owning multiple HTB securities. In other words, each household encompasses all accounts tied to clients living at that household address. In such examples, numerous attributes (e.g., over 400 different attributes) may represent predictors for each entire household for identifying the targeted set of prospect accounts to participate in the securities lending program. In various embodiments, the attributes may relate to, for example, demographic data for the household, trading patterns for the household, portfolio data for the household, digital behavior for the household, etc. As examples only, the attributes may include a last trading activity, the frequency of trading, an engagement score, total assets, percentage of portfolio in stocks, opted-in to receive mail, different levels of options trading approval, internet activity frequency, location, etc. In various embodiments, the engagement score may be a decile score (e.g., between 0 and 10) based on how frequently a client has initiated communication with a company (e.g., chats, phone calls, emails, etc. from the client to the company). In such examples, the engagement score may be based on recent client engagement activity, such as over the past six months, etc.

Further, the forecasted data includes predicted financial attributes specific to the households. For example, the predicted financial attributes may include a score representing a predicted level of household financial knowledge, a score representing a predicted level of household financial experience, etc. In such examples, the predicted levels of household financial knowledge, experience, etc. may be generated based on the attributes (e.g., trading patterns for the household, the frequency of trading, different levels of options trading approval, etc.) associated with the households. In some examples, and as further explained herein, the financial attributes (e.g., scores) may be predicted by another ML model.

As shown in FIG. 1, the possible mixture of original, raw data and/or engineered features is then sent from the data transform server 108 to the ML server 110 via a batch or a data stream. More specifically, the data is provided to the input of the ML server 110. In other examples, the data transform server 108 may be optionally implemented, and therefore removed from the system 100. In such examples, the datasets are received by the ML server 110 from the data sources 102, 104, 106. Alternatively, portions or all of the datasets from the data sources 102, 104, 106 may bypass the data transform server 108 and be received by the ML server 110.

In various embodiments, the ML server 110 receives at least one dataset having the securities data, the household data, and the forecasted data, and then the ML model 124 determines a model score or value for each household based on the received dataset. In such examples, the model score represents the likelihood of a household having an existing client that would participate (e.g., enroll) in the securities lending program for option trading activities. Each model score or value may range between any two suitable endpoints. For example, the model score or value may be a normalized value between 0 and 1, 0 and 10, 0 and 100, etc.

The ML model 124 implemented by the ML server 110 may be any suitable type of model, such as a supervised learning model. For example, the ML model 124 may be a rule-based scoring technique to generate a model score for each household. For instance, the ML model 124 may be a decision tree-based ML algorithm, such as an extreme gradient boosting (XGBoost) ML algorithm that provides an ensemble of tree structured predictive models for generating the model score for each household. In such examples, the ML server 110 may use a greedy algorithm to find the best split of rules. In other examples, the ML model 124 may be another suitable decision tree-based ML algorithm, such as a random forest ML algorithm, a decision tree ML algorithm, etc.

In the examples herein, the model score for each household may be generated based on various conditions and rules associated therewith. For example, to score a household with the ML model 124, various data points may be fetched from a database, such as data points related to the attributes for training the ML model 124 as further explained below. Then, the ML server 110 may convert such data points into numerical data in any suitable manner (e.g., by hot encoding, etc.). In such examples, if a data point is not present (e.g., for new customers) or not computed, the ML server 110 may replace that data point with zero (e.g., a null numerical value). Then, the trained ML model 124 may be loaded by the ML server 110 and leveraged to score the household. This score may range between any two suitable endpoints (e.g., 0 and 1), as explained above. In some examples, the generated score may be converted to deciles with the help of decile ranges obtained while training the model.

In the example of FIG. 1, the ML model 124 may be initially trained prior to and/or while generating the model scores. For example, the ML model 124 may be trained and/or retrained (e.g., tuned, etc.) according to various attributes that result in clients participating in the securities lending program. In such examples, the ML model 124 may be trained and/or retrained based on the same dataset(s) received during model scoring. For instance, the ML model 124 may be trained on securities data, household data, and forecasted data that resulted in clients participating in the securities lending program. As such, the ML model 124 may be trained on hundreds of different attributes specific to households that actually participate in the securities lending program. In various embodiments, the ML model 124 may be sufficiently trained when one or more of its performance metrics (e.g., accuracy, precision, recall, f1-score, etc.) on test data is about 10% or less, 5% or less, etc.

In some examples, the attributes for training the ML model 124 may relate to household and/or client attributes. For example, the ML model 124 may be trained based on data relating to households trading data, digital activity on the brokerage platform, demographic and interaction with our client service and support teams (e.g., calls, chat, branch interactions, chatbot etc.), movement of funds across accounts, client knowledge levels based on trading, etc. As example only, some specific attributes may include (but are not limited to) recent trading activity in the household, an engagement score for a client, assets held at the company by the household, percentage of portfolio in stock, communication preference, options trading approval levels for customer(s) in the households, number of client logins, net assets flow into accounts, etc.

Additionally, in some examples, multiple weeks, months, years, etc. of data may be collected for the training and testing of the ML model 124 (and/or another ML model herein). In such examples, the collected data may be split by years, months, etc. into training data and testing data. For example, data from a period of time (e.g., two weeks, one month, one year, four years, six years, etc.) may be leveraged to train the ML model 124. Then, after training, similar data from a different period of time may be leveraged for testing. In such examples, the testing data may span over the same or different amount of time as the training data.

In various embodiments, the performance of the ML model 124 is robust. For example, during training, the ML model 124 may have a receiver operating characteristic area under the curve (ROC AUC) score of 0.94. Additionally, the ML model 124 may be validated during implementation. In such examples, the ML model 124 may have a ROC AUC score of 0.92. If the validation score falls below a defined threshold (e.g., 0.85, 0.87, 0.9, etc.), the ML model 124 may be retrained (e.g., tuned, etc.) as referenced above.

In some examples, households associated with the received datasets from the data sources 102, 104, 106 may be optionally filtered before passing to the ML server 110. For example, a server similar to the rule server 112 and/or the rule server 115 may optionally filter households associated with the received datasets based on defined criteria to narrow the collection of households for the ML model 124 to score. With such filtering, computations by the ML server 110, the prioritization server 114, and/or other downstream servers may be reduced, thereby reducing the usage of memory and processing resources. In such examples, the filter may remove households based on basic threshold eligibility of the customers in the households and/or their accounts. For example, this filter may remove households that that do not meet minimal thresholds relating to assets held by the company, revenue (for the households and/or customer(s) in the households), options trading approval levels for customer(s) in the households, specific HTB stocks held by customer(s) in the households, etc. As shown in FIG. 1, the rule server 112 is in communication with the ML server 110. In the example of FIG. 1, the rule server 112 may function as a filtering component to filter households based on various different criteria to generate a set of remaining households (e.g., about 20 households). In various embodiments, the rule server 112 may apply one or more defined rules to each received household and/or model score received from the ML server 110.

For example, the rule server 112 may filter (e.g., exclude) households based on a threshold score rule. In such examples, the rule server 112 filters the households based on a model score for each household determined by the ML model 124 and a threshold score. In such examples, the rule server 112 may compare each model score (or a derivation thereof) and a threshold score, and then exclude any household having a model score falling below the threshold score.

In other examples, the rule server 112 may filter households based on other defined rules relating to marketable criteria, product criteria, past client responses, recent trading activity, etc. In such examples, the rule server 112 may filter out households based on user input, ineligible accounts for the securities lending program, etc. For example, if a household includes a client that selects an input indicating a do not call/communicate option or a do not disturb option, that household may be excluded from the set of remaining households. Additionally, a household may be excluded from the set of remaining households if it includes an existing client having less than a defined value (e.g., $1,000, $10,000, etc.) in assets at the investment company implementing the securities lending program. Further, a household may be excluded from the set of remaining households if the household includes an account that is not individually (e.g., employee) controlled. Furthermore, a household may be excluded if a client in the household responds to an inquiry with a desire not to participate in the program. In addition, a household may be excluded if clients in the household are employees of the same company as the HTB security. In still other examples, a household may be excluded if a client already has covered calls (e.g., shares of the HTB security are already loaned out), recently made a trade with respect to a HTB security, etc.

Once the households are filtered, the remaining households are provided to the prioritization server 114 for further analysis. Specifically, after receiving remaining households, the prioritization server 114 determines a prioritization score for each remaining household. In such examples, the prioritization score for each remaining household may represent an estimated household revenue potential per month if a client in the household participates in the securities lending program. In various embodiments, the prioritization score may be determined based on a price, a household quantity, and the demand rate of each HTB security in question. If the household has multiple HTB securities, the prioritization score for each HTB security may be aggregated into a total prioritization score for the household. As an example only, the prioritization score may be determined for each household according to the equation below, where the household may have one or multiple accounts owned by one individual or different individuals, and each account may have one or multiple HTB securities.

Σ(Price per share x Household share quantity×(the demand rate/1200))

Then, once the prioritization score for each remaining household is determined, the prioritization server 114 leverages the score prioritization scores to prioritize a set of possible clients (e.g., leads) with accounts that would most likely be amenable to participating in the securities lending program. In such examples, the prioritization server 114 may order the households in a descending manner based in part on the prioritization scores, with the highest prioritization score corresponding to the household with an existing client with an account that most likely would participate in the securities lending program.

In some examples, the prioritization score for each household and/or the prioritization of the possible clients may be generated based on various conditions and rules associated therewith. For example, prioritization scores and/or the prioritization of the possible clients may be based on a sales team capacity (e.g., the number of analysts to generate communications with clients/customers, etc.), third party HTB securities, model score deciles (e.g., the top two deciles), a minimum estimated revenue set by sales teams (e.g., $500, $1,000, $10,000, etc.), etc. In various embodiments, the decile cut offs may be saved and leveraged while training and testing the ML model 124.

In various embodiments, the prioritized set of possible clients may pass through another filtering server, such a rule server similar to the rule server 112. In such examples, an optional rule server 115 may be downstream of the prioritization server 114 to implement filtering of the household data to reduce computations for the system 100. For instance, some heavy computational filtering aspects may be implemented after the prioritized set of possible clients is determined (instead of before in the rule server 112) to reduce the usage of memory and processing resources, thereby providing a technical advantage to the system 100. For example, in some embodiments, the rule server 115 excludes from the prioritized set of possible clients any clients already having covered calls (e.g., shares of the HTB security are already loaned out), clients that have been recently contacted (e.g., within six months, etc.), clients that are employees of the same company as the HTB security, etc.

Next, the system 100 may generate and display a user interface including a list of the prioritized remaining households from the prioritization server 114 as prospect accounts from the pool of existing accounts for participating in the securities lending program. More specifically, the alert generation server 116 may receive the prioritized remaining households from the prioritization server 114 and then in response, generate the user interface (e.g., a GUI) with the remaining households. In such examples, the user interface may be transmitted by the alert generation server 116 to the SOC 118 for display and/or the communications server 120, as shown in FIG. 1.

The system 100 may also provide model explainability features in the user interface, along with the list of the prioritized remaining households. The model explainability features may include one or more reasons why a particular client at each household may be interested in participating in the securities lending program. In such examples, the reasons may be generated and output by the ML model 124 based on household features. In various embodiments, the reasons may include aspects relating to a household (e.g., household revenue, household assets, etc.), a client in the household (e.g., age, gender, how deposits are made, options approval, an engagement score, an online presence, etc.). In some examples, analysts may specify reasons (e.g., age, gender, etc.) to be included in the user interface. The provided reasons may, for example, assist analysts in framing a communication (e.g., set the tone, narrative, etc. of a conversation, email, etc.) with a client, etc., thereby reducing the time required to prepare for the communication.

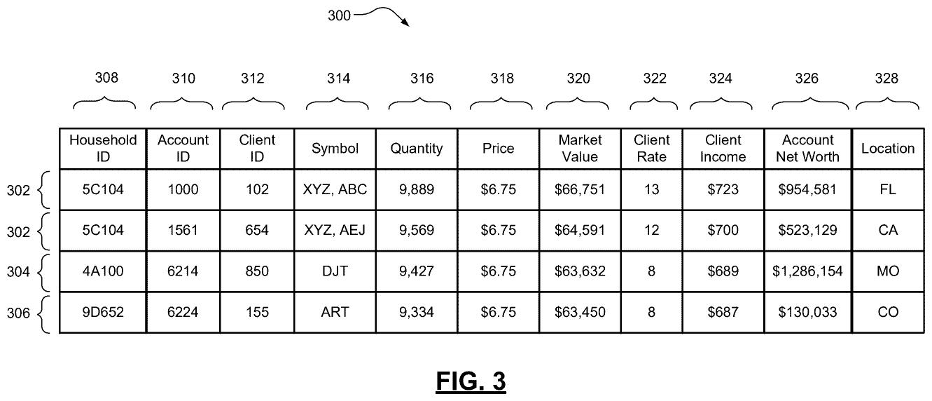

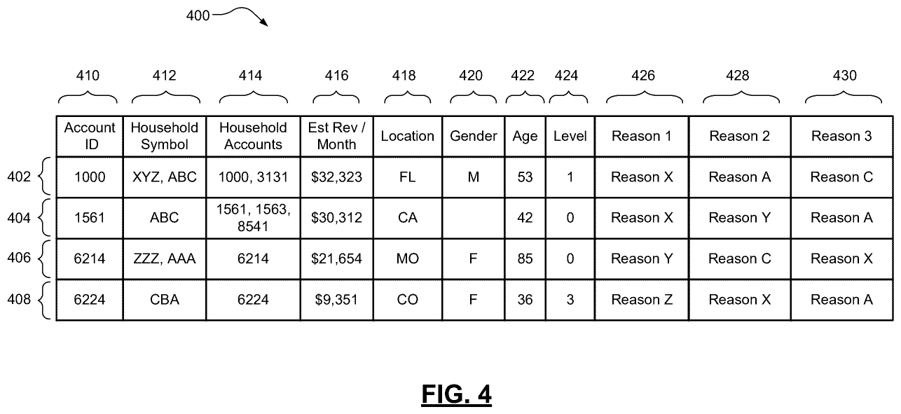

In various embodiments, the list of the prioritized remaining households may have any suitable configuration. For example, the list of the prioritized remaining households may order each household according to its prioritization score, and provide various other useful information (e.g., location data, demographic data, financial data, account data, etc.) about the household, a particular HTB security, etc. As examples only, FIGS. 3-4 illustrate user interfaces 300, 400 for lists of the prioritized remaining households that may be provided to the SOC 118 and/or the communications server 120. In such examples, the user interfaces 300, 400 may be GUIs having selectable inputs (e.g., selectable household data, account data), thereby allowing users to ascertain more detailed information about the selected input. While the user interfaces 300, 400 include specific data points for a specific number of households as further explained below, it should be appreciated that the user interfaces 300, 400 and/or other suitable charts may list more or less data points for more or less households if desired.

As shown in FIG. 3, the user interface 300 includes various data points for four different households 302, 304, 306. Specifically, the user interface 300 includes columns 308, 310, 312, 314, 316, 318, 320, 322, 324, 326, 328 including data points for each household 302, 304, 306. For example, the columns 308, 310, 312 provide household IDs, account IDs and client IDs, respectively, for the households 302, 304, 306. As shown, the household 302 (household ID 5C104) includes two different accounts (account IDs 1000 and 1561) owned by two different clients (client IDs 102 and 654). Additionally, the columns 314, 316, 318, 320 provide specific HTB stock symbol(s), a household quantity for that HTB stock, a price per share for the HTB stock, and a market value of the HTB stock (e.g., the household quantity multiplied by the price per share), respectively. In this example, the accounts in the household 302 have multiple HTB securities (XYZ, ABC and AEJ). As such, the household 302 has multiple accounts owned by different individuals, with each account having multiple HTB securities.

In the example of FIG. 3, the columns 322, 324, 326, 328 provide a client rate, a client income, an account net worth, and a household location (e.g., Florida, California, Missouri, and Colorado), respectively. In the example of FIG. 3, the client rate represents an amount paid for lending out the security, the client income represents a monthly income of the account holder, and the account net worth represents total value of the account including the market value for the HTB stock. In some examples, the household location may be leveraged to provide best times to communicate (e.g., call, etc.) with the client. For example, time zones are associated with household locations. As such, one time may be better to call someone in Florida (e.g., in the Eastern time zone), whereas another time may be better to call someone in California (e.g., in the Pacific time zone).

In FIG. 4, the user interface 400 includes various data points for four different households 402, 404, 406, 408. As shown, the user interface 400 includes columns 410, 412, 414, 416, 418, 420, 422, 424, 426, 428, 430 including data points for each household 402, 404, 406, 408. In this example, the column 410 provides an account ID for each household 402, 404, 406, 408, the column 412 provides a list of HTB stocks held by each household 402, 404, 406, 408, the column 414 provides a list of individual client accounts of each household 402, 404, 406, 408, and the column 416 provides an estimated household revenue per month (e.g., the prioritization score generated by the prioritization server 114 of FIG. 1) for each household 402, 404, 406, 408. For example, the household 402 is shown as including the estimated household revenue per month (or the highest prioritization score) and two different existing client accounts (e.g., 1000, 3131). In this example, some combination of the existing client accounts in the household 402 include HTB stocks XYZ, ABC.

Additionally, the columns 418, 420, 422 provide a location, a gender (if provided), and an age, respectively, of an existing client in each household 402, 404, 406, 408. The column 424 provides an options trading approval level for an existing client in each household 402, 404, 406, 408. In such examples, the options trading approval level may range between level 0 and level 3 (or another suitable value) to indicate a user selectable input for different options trading activities. Lastly, the columns 426, 428, 430 provide reasons 1, 2, 3, respectively for why a client at each household 402, 404, 406, 408 may be interested in the securities lending program. In such examples, the provided reasons (e.g., Reason X, Reason Y, Reason Z, Reason A and Reason C) may include aspects relating to a household (e.g., household revenue, household assets, etc.), a client in the household (e.g., age, gender, how deposits are made, options approval, engagement level, online presence, etc.), as explained above.

With continued reference to FIG. 1, the system 100 may initiate communication with a specific client associated with an existing client account. For example, an analyst in the SOC 118 may receive a user interface including a list (e.g., the user interface 400 of FIG. 4) of the prioritized remaining households from the prioritization server 114 and then initiate communication with a client in the household having the highest prioritization score. For instance, if the analyst in the SOC 118 receives the user interface 400 of FIG. 4, the analyst may email, call, text, etc. with a client associated with the household 402.

In some examples, the system 100 may automatically initiate communication with a client associated with an existing client account in response to receiving the user interface from the alert generation server 116. In such examples, the user interface may function as an alert and the communications server 120 may automatically generate an electronic message (e.g., an email, a text message, an automated phone call, etc.) with a client associated with an existing client account in the household having the highest prioritization score, such as a client associated with the household 402, etc. With this approach, the communications server 120 may initially provide a message to the client about the securities lending program, and then an analyst in the SOC 118 may follow up with the client in due course if, for example, the client indicates some level of interest.

Then, in some embodiments, the system 100 may generate a user interface including a report with a client response of the initiated communication. For example, in the example of FIG. 1, the feedback response server 122 may generate the report with a client response of the initiated communication based on feedback from the analyst in the SOC 118 and/or the communications server 120. This generated report may include various data points, such as the client's name, account information, the date/time of the most recent initiated communication (along with other previous communications) with the client, specific HTB security positions owned by the client, etc. Then, if desired, the feedback response server 122 may generate the user interface (e.g., a GUI) with the report for display.

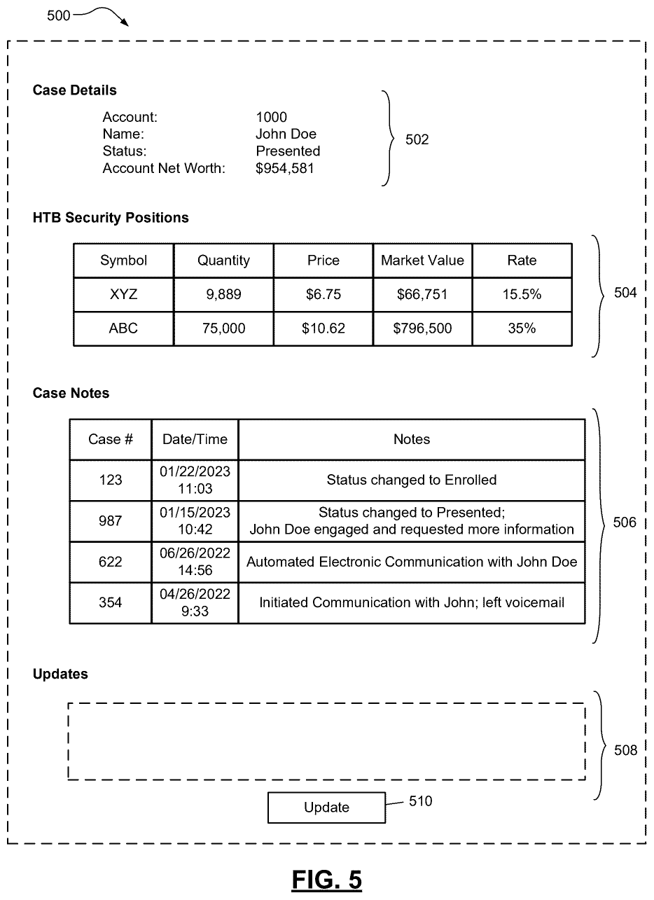

FIG. 5 illustrates one example a user interface 500 including a report with such information. For example, and as shown in FIG. 5, the user interface 500 includes a section 502 for case details, a section 504 for HTB security positions, a section 506 for case notes, and a section 508 for updates. More specifically, the section 502 includes an account number, the client's name, a status, and an account net worth (e.g., the total value of the account including the market value for the HTB stocks held in the account). In this example, the status is shown as “presented” indicating that the client has been provided information about and an offer to join the securities lending program. In other examples, the status may be another suitable identifier, such as “working” which may indicate that an initial communication (e.g., a voicemail, an email, etc.) has been provided to the client who has been identified by the system 100 as a likely participate in the securities lending program. In the section 504, the user interface 500 provides a listing of each HTB stock held in the account, a quantity of each HTB stock, a price per share for each HTB stock, a market value for each HTB stock, and a demand rate for each HTB stock. The section 506 provides a listing of notes, including a case number, a date/time of each communication with the client, and a brief summary of the communication with the client. The section 508 provides an optional input for adding additional notes not included in the section 506. In such examples, an analyst may input the additional notes into the section 508 and select an input 510 (e.g., with a user input (e.g., a mouse, etc.), a touch screen, etc.) to update the report.

With continued reference to FIG. 1, the system 100 may rely on the generated report with the client response from the feedback response server 122 and/or other information from the alert generation server 116, the SOC 118, etc. For example, and as shown in FIG. 1, the report or data therein may be fed back to the ML server 110 for continually training (or retraining, tuning, etc.) the ML model 124, and to the rule server 112 for updating different exclusion rules and applying existing exclusion rules. For instance, the rule server 112 may exclude a household if a client at the household was recently contacted. In such examples, the rule server 112 may rely on the date/time of contacts in the report of FIG. 5 for such filtering. In other examples, the client response of the initiated communication may indicate that the client is not interested. In such examples, the household with that client may be excluded at the rule server 112.

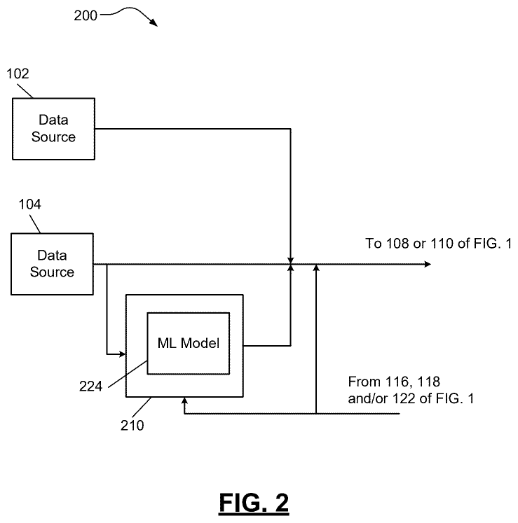

Additionally, in some examples, the client response may be used as another data source in the dataset received by the ML server 110 (or the data transform server 108). For example, FIG. 2 illustrates a portion of a system 200 that may be implemented with the system 100 if desired. As shown, the system 200 includes the data sources 102, 104 of FIG. 1 for providing one or more datasets having securities data and household data to the ML server 110 or the data transform server 108 of FIG. 1. Additionally, and as shown in FIG. 2, the system 200 includes feedback data provided to the ML server 110 (or the data transform server 108) from the feedback response server 122, the alert generation server 116, and/or the SOC 118. In such examples, the feedback data may include trading patterns of clients in specific households, digital data (e.g., online activity, etc.) and call data from the client response. Such data may be utilized when generating model scores as explained above.

In various embodiments, the system 200 may include one or more ML models for providing another data source for the ML server 110. In such examples, the ML models may be any suitable type of model, such as a linear regression model, a logistic regression model, a decision tree model, a random forest model, a gradient boosting algorithm, etc. For example, and as shown in FIG. 2, the system 200 includes a ML server 210 for providing additional data to the ML server 110 or the data transform server 108 of FIG. 1, such as the forecasted data as explained above. More specifically, the ML server 210 of FIG. 2 may receive household data from the data source 104. In such examples, the household data includes various attributes associated with the households. Then, the ML server 210 can execute one or more ML models 224 to generate predicted financial attributes specific to the households based on the received attributes associated with the households. In some examples, the predicted financial attributes may include a score representing a predicted level of household financial knowledge, a score representing a predicted level of household financial experience, etc. as explained above. In various embodiments, the ML model(s) 224 may take into account the client responses from the feedback response server 122 when generating the financial attributes.

While certain components of the systems 100, 200 associated with a machine learning based framework are shown in FIGS. 1-2, the example embodiments are not limited thereto, and the system 100 and/or the system 200 may include components other than that shown in FIGS. 1-2.

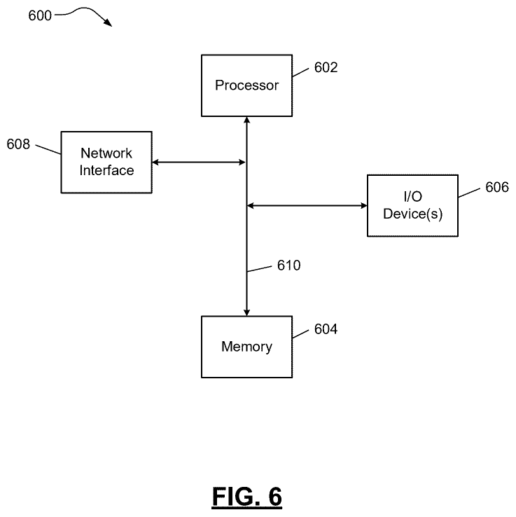

89 FIG. 6 illustrates a block diagram of an example computing device 600 of the machine learning based framework according to at least one example embodiment. The computing device 600 of FIG. 6 may correspond to or include the data transform server 108, the ML server 110, the ML server 210, the rule server 112, the prioritization server 114, the alert generation server 116, the communications server 120, and/or the feedback response server 122 of FIGS. 1-2, but the example embodiments are not limited thereto.

As shown in FIG. 6, the computing device 600 may include processing circuitry (e.g., at least one processor 602), at least one communication bus 610, memory 604, at least one network interface 608, and/or at least one input/output (I/O) device 606 (e.g., a keyboard, a display screen, a touchscreen, a mouse, a microphone, a camera, a speaker, etc.), etc., but the example embodiments are not limited thereto. In the example of FIG. 6, the memory 604 may include various special purpose program code including computer executable instructions which may cause the computing device 600 to perform the one or more of the methods of the example embodiments, including but not limited to computer executable instructions related to the machine learning based framework explained herein.

In at least one example embodiment, the processing circuitry may include at least one processor (and/or processor cores, distributed processors, networked processors, etc.), such as the processor 602, which may be configured to control one or more elements of the computing device 600, and thereby cause the computing device 600 to perform various operations. The processing circuitry (e.g., the processor 602, etc.) is configured to execute processes by retrieving program code (e.g., computer readable instructions) and data from the memory 604 to process them, thereby executing special purpose control and functions of the entire computing device 600. Once the special purpose program instructions are loaded (e.g., into the processor 602, etc.), the processor 602 executes the special purpose program instructions, thereby transforming the processor 602 into a special purpose processor.

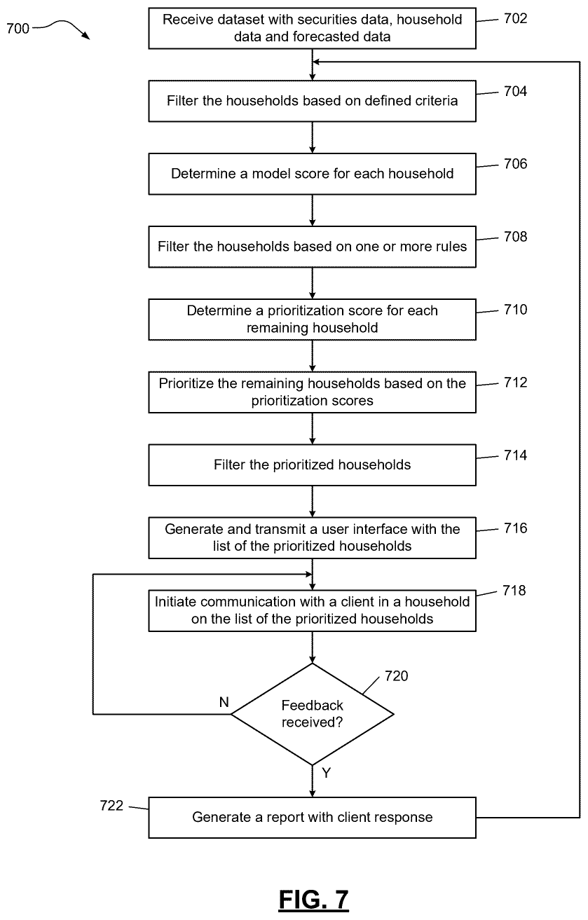

In at least one example embodiment, the memory 604 may be a non-transitory computer-readable storage medium and may include a random access memory (RAM), a read only memory (ROM), and/or a permanent mass storage device such as a disk drive, or a solid state drive. Stored in the memory 604 is program code (i.e., computer readable instructions) related to operating the machine learning based framework as explained herein, such as the methods discussed in connection with FIG. 7, the network interface 608, and/or the I/O device 606, etc. Such software elements may be loaded from a non-transitory computer-readable storage medium independent of the memory 604, using a drive mechanism (not shown) connected to the computing device 600, or via the network interface 608, and/or the I/O device 606, etc.

In at least one example embodiment, the at least one communication bus 610 may enable communication and/or data transmission to be performed between elements of the computing device 600. The bus 610 may be implemented using a high-speed serial bus, a parallel bus, and/or any other appropriate communication technology. According to some example embodiments, the computing device 600 may include a plurality of communication buses (not shown).

While FIG. 6 depicts an example embodiment of the computing device 600, the computing device 600 is not limited thereto, and may include additional and/or alternative architectures that may be suitable for the purposes demonstrated. For example, the functionality of the computing device 600 may be divided among a plurality of physical, logical, and/or virtual servers and/or computing devices, network elements, etc., but the example embodiments are not limited thereto.

FIG. 7 illustrates an example method 700 for identifying a targeted set of potential customers from a pool of existing customers, according to at least one example embodiment. As shown, the method 700 begins in operation 702 where a server, such as the data transform server 108 or the ML server 110 of FIG. 1, receives and/or obtains one or more datasets with the securities data, the household data, and the forecasted data, as explained herein. Then, in operation 704, a server may optionally filter households associated with the received datasets based on defined criteria to narrow the collection of households to score in one or more subsequent operations, thereby reducing computations in subsequent operations. In such examples, the filter may narrow the collection of households based on basic threshold eligibility of the customers in the households and/or their accounts. For example, this filter may remove households that that do not meet minimal thresholds relating to assets held by the company, revenue (for the households and/or customer(s) in the households), options trading approval levels for customer(s) in the households, specific HTB stocks held by customer(s) in the households, etc. The method 700 then proceeds to operation 706.

At operation 706, an ML model (e.g., the ML model 124 of FIG. 1) determines a model score for each household based on the received datasets and received engagement scores, as explained above. In various embodiments, the ML model may determine model scores for only the households passing through the filter in operation 704. For example, and as explained above, the model score may be a rule-based score ranging between any two suitable endpoints (e.g., 0 and 1). In some examples, the model score may be generated based on received data points that are converted into numerical data, which is then leveraged to score the household. If desired, the score may be converted to deciles with the help of decile ranges obtained while training the model, as explained above. In various embodiments, the ML model may determine model scores for vast amount of household, such as over one million different households, etc. The method 700 then proceeds to operation 708.

At operation 708, a server, such as the rule server 112 of FIG. 1, filters the households based on one or more defined rules to generate a set of remaining households. For example, the server may apply the defined rules to each received household and/or model score received from the ML model. In various embodiments, the rule server 112 may exclude households having model scores that fall below a threshold score, households based on user input (e.g., do not disturb requests, etc.), households having ineligible accounts for the securities lending program, etc. as explained herein. The method 700 then proceeds to operation 710.

At operation 710, a server, such as the prioritization server 114 of FIG. 1, determines a prioritization score for each remaining household. For example, and as explained herein, the server may determine a prioritization score (e.g., estimated household revenue per month) for each remaining household based on a price, a household quantity, the demand rate of each HTB security, sales team capacity (e.g., the number of analysts to generate communications with clients/customers, etc.), third party HTB securities, model score deciles (e.g., the top two deciles), a minimum estimated revenue set by sales teams (e.g., $500, $1,000, $10,000, etc.), etc. Then, in operation 712, the server prioritizes the remaining households based on the prioritization scores. For example, the server may list the remaining households in a descending order based on the prioritization scores. The method 700 then proceeds to operation 714.

At operation 714, the method 700 may implement another optional filter after the server prioritizes the remaining households based on the prioritization scores. In such examples, another rule server (e.g., the rule server 115 of FIG. 1) may implement computationally heavy filtering, such as excluding clients already having covered calls (e.g., shares of the HTB security are already loaned out), clients that have been recently contacted, clients that are employees of the same company as the HTB security, etc., as explained above. The method 700 then proceeds to operation 716.

At operation 716, a server, such as the alert generation server 116 of FIG. 1, generates a user interface (e.g., a GUI) including a list of the prioritized remaining households as prospect accounts from the pool of existing accounts for participating in the securities lending program. In such examples, the server may transmit the user interface with the prioritized remaining households to one or more other servers and/or components, such as the SOC 118 and/or the communications server 120 of FIG. 1. The method 700 then proceeds to operation 718.

At operation 718, communication is initiated with a client associated with an existing client account in a household on the list of prioritized remaining households. For example, the SOC 118 (e.g., an analyst therein) of FIG. 1 may initiate communication with the client associated with an existing client account in the household having the highest prioritization score. In such examples, the analyst may select an input on the user interface to initiate the communication (e.g., originate and/or send an electronic message, initiate a call, etc.). In other examples, the communications server 120 of FIG. 1 may automatically initiate communication with the client in the household having the highest prioritization score. The method 700 then proceeds to operation 720.

At operation 720, a server, such as the feedback response server 122 of FIG. 1, determines whether any client feedback is received. If no, the method 700 may return to operation 718 where communication is again initiated with the same client or a different client in a household on the list of prioritized remaining households. Alternatively, the method 700 may end if desired. If client feedback is received, the method 700 proceeds to operation 722 where a report is generated (e.g., in the form of a user interface) with the client response, as explained herein. Then, the method 700 may return to operation 704 or end if desired. In some examples, the client feedback may be provided for use in determining the model scores, training the ML model, etc. as explained herein.

Various example embodiments herein are directed towards an improved device, system, method and/or non-transitory computer readable medium for a machine learning based framework employing one or more ML models that identify a targeted set of prospect accounts from a pool of existing accounts for participating in a securities lending program that, for example, makes HTB securities available to investors or financial institutions (e.g., hedge funds, etc.) requesting such securities for various option trading activities. In such examples, the framework generates model scores for households having one or more accounts with the ML models, filters out any undesirable households, prioritizes the remaining households based on specific criteria, and generates user interfaces with the prioritized households having prospect accounts for participating in the securities lending program. Then, the framework or analysts for the securities lending program may initiate communication with clients associated with the prospect accounts of the prioritized households. With this configuration, the framework efficiently and accurately identifies and prioritizes a set of manageable households (e.g., out of over one million different households) having clients with accounts that would most likely be amenable to participating in the securities lending program.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A system for identifying a targeted set of prospect clients from a pool of existing clients, the system comprising:
a memory storing computer readable instructions; and
processing circuitry configured to execute the computer readable instructions to cause the system to,
receive a dataset having securities data, household data, and forecasted data, the securities data including hard-to-borrow (HTB) securities and a demand rate for each HTB security of the HTB securities, the household data including attributes specific to households, the forecasted data including predicted financial attributes specific to the households, and each household including at least one client associated with at least one existing account owning at least one HTB security of the HTB securities,
determine, with a machine learning model, a model score for each household of the households based on the received dataset,
filter the households based on the model score for each household and a threshold score to generate remaining households,
determine a prioritization score for each remaining household of the remaining households based on a price, a household quantity, and the demand rate of the at least one HTB security,
prioritize the remaining households based on the prioritization score for each remaining household of the remaining households, and
generate and display a user interface including a list of the prioritized remaining households having prospect clients from the pool of existing clients.

2. The system of claim 1, wherein the system is further caused to initiate communication with a client associated with an existing client account in the household having the highest prioritization score.

3. The system of claim 2, wherein the system is further caused to automatically initiate communication with the client in response to the generated user interface.

4. The system of claim 2, wherein the existing client account in the household having the highest prioritization score is a first existing client account, wherein the household having the highest prioritization score includes a second existing client account of the pool of existing accounts and the client.

5. The system of claim 2, wherein the system is further caused to generate a report with a client response of the initiated communication.

6. The system of claim 5, wherein the machine learning model is a first machine learning model and wherein the financial attributes specific to the households are predicted by a second machine learning model based on the attributes associated with the households and the client response.

7. The system of claim 5, wherein the system is further caused to filter the households based on at least one of existing client input, a total number of assets, and the client response.

8. The system of claim 1, wherein the machine learning model includes a decision tree machine learning algorithm.

9. The system of claim 1, wherein the machine learning model is a first machine learning model and wherein the financial attributes specific to the households are predicted by a second machine learning model based on the attributes associated with the households.

10. The system of claim 1, wherein the system is further caused to train the machine learning model based on the received dataset.

11. A method for identifying a targeted set of prospect clients from a pool of existing clients, the method comprising:
receiving, at a machine learning model, a dataset having securities data, household data, and forecasted data, the securities data including hard-to-borrow (HTB) securities and a demand rate for each HTB security of the HTB securities, the household data including attributes specific to households, the forecasted data including predicted financial attributes specific to the households, and each household including at least one client associated with at least one existing account owning at least one HTB security of the HTB securities,
determining, with the machine learning model, a model score for each household of the households based on the received dataset,
filtering the households based on the model score for each household and a threshold score to generate remaining households,
determining a prioritization score for each remaining household of the remaining households based on a price, a household quantity, and the demand rate of the at least one HTB security,
prioritizing the remaining households based on the prioritization score for each remaining household of the remaining households, and
generating and displaying a user interface including a list of the prioritized remaining households having prospect clients from the pool of existing clients.

12. The method of claim 11, further comprising automatically initiating electronic communication with a client associated with an existing client account in the household having the highest prioritization score.

13. The method of claim 12, wherein the existing client account in the household having the highest prioritization score is a first existing client account, wherein the household having the highest prioritization score includes a second existing client account of the pool of existing accounts and the client.

14. The method of claim 12, further comprising generating a report with a client response of the initiated communication.

15. The method of claim 14, wherein the machine learning model is a first machine learning model and wherein the financial attributes specific to the households are predicted by a second machine learning model based on the attributes associated with the households and the client response.

16. The method of claim 14, wherein filtering the households includes filtering the households based on at least one of existing client input, a total number of assets, and the client response.

17. The method of claim 11, wherein the machine learning model includes a decision tree machine learning algorithm.

18. The method of claim 11, further comprising training the machine learning model based on the received dataset.

19. A non-transitory computer readable medium storing computer readable instructions, which when executed by processing circuitry, causes a system including the processing circuitry to:
receive a dataset having securities data, household data, and forecasted data, the securities data including hard-to-borrow (HTB) securities and a demand rate for each HTB security of the HTB securities, the household data including attributes specific to households, the forecasted data including predicted financial attributes specific to the households, and each household including at least one client associated with at least one existing account owning at least one HTB security of the HTB securities
determine, with a machine learning model, a model score for each household of the households based on the received dataset,
filter the households based on the model score for each household and a threshold score to generate remaining households,
determine a prioritization score for each remaining household of the remaining households based on a price, a household quantity, and the demand rate of the at least one HTB security,
prioritize the remaining households based on the prioritization score for each remaining household of the remaining households, and
generate and display a user interface including a list of the prioritized remaining households.

20. The non-transitory computer readable medium of claim 19, wherein the system is further caused to automatically initiate communication with a client associated with an existing client account in the household having the highest prioritization score.
